(19) United States
(12) Patent Application Publication
(10) Pub. No.: US 2005/0249912 A1
(43) Pub. Date: Nov. 10, 2005

(54) Floor covering containing polyvinyl butyral and method of making same

(75) Inventors: Brian S. Randall, Calhoun, GA (US); Paul D. Evans JR., Sugar Valley, GA (US); Wallace J. Hammel, Ringgold, GA (US)

Correspondence Address: WOMBLE CARLYLE SANDRIDGE & RICE, PLLC, P.O. BOX 7037, ATLANTA, GA, 30357-0037, US

(73) Assignee: C&A Floorcoverings, Inc.

(21) Appl. No.: 11/122,916

(22) Filed: May 5, 2005

Related U.S. Application Data
(60) Provisional application No. 60/568,966, filed on May 6, 2004.

(51) Int. Cl. B32B 33/00; D05C 17/02

(52) U.S. Cl. 428/95; 442/30; 442/56

(57) ABSTRACT

A backing for a floor covering and a floor covering including such a backing are provided. Methods of making such a backing and a floor covering also are provided.

### CROSS-REFERENCE TO RELATED APPLICATION

This application claims the benefit of U.S. Provisional Application 60/568,966 filed May 6, 2004.

### BACKGROUND

Carpets and other floor coverings may include one or more components that are formed from recycled or reclaimed thermoplastic polymeric materials that contain volatile organic compounds (VOC's). Carpets and floor coverings including such recycled or reclaimed thermoplastic polymeric materials must meet stringent limits on the level of VOC's emitted from the products.

### SUMMARY

According to one aspect of the present invention, a reinforced foam backing for a floor covering such as, for example, carpet, includes a foam sheet comprising polyvinyl butyral. The foam sheet has a plurality of cells formed therein, and at least one reinforcing material joined with the foam sheet. The polyvinyl butyral may comprise recycled polyvinyl butyral, virgin polyvinyl butyral, or any combination thereof.

According to another aspect of the invention, a floor covering comprises a carpet including a plurality of textile fibers at least partially embedded in a polymeric pre-coat layer comprising a polyurethane, and a foam backing comprising polyvinyl butyral attached to the carpet.

According to yet another aspect, a floor covering includes a backing comprising recycled polyvinyl butyral. The floor covering has a total volatile organic compound emission factor of less than about 1 mg/m²/hr as measured according to ASTM D-5116-1990. The backing used in the floor covering may be a foam.

According to still another aspect of the invention, a floor covering comprises a carpet including a plurality of textile fibers, a foamed backing including polyvinyl butyral joined to the carpet, and a polymeric pre-coat layer joining the carpet to the foamed backing. The floor covering has a total volatile organic compound emission factor of less than about 0.5 mg/m²/hr as measured according to ASTM D-5116-1990. The polymeric pre-coat layer may include a polyurethane, polyvinyl butyral, polyvinyl chloride, or any combination thereof.

The invention also contemplates a method of manufacturing a floor covering. The method includes extruding a polymeric material mixture comprising molten polyvinyl butyral and a blowing agent or cell-forming material, calendering the extruded polymeric mixture to form a sheet, and heating the sheet to form a foamed polyvinyl butyral backing.

The invention further contemplates a method of making floor covering including a recycled PVB foam backing. The floor covering has a total volatile organic compound emission factor of less than about 0.5 mg/m²/hr as measured according to ASTM D-5116-1990. The method includes extruding a polymeric material mixture comprising molten recycled polyvinyl butyral and a cell-forming material, calendering the extruded polymeric mixture to form a sheet, and heating the sheet to form a foamed polyvinyl butyral backing, where at least one of the extruding, calendering, and heating are carried out at a temperature sufficient to release volatile organic compounds from the polymeric material mixture.

These and other aspects are set forth in greater detail in the detailed description below and in the accompanying drawings.

### BRIEF DESCRIPTION OF THE DRAWINGS

FIG. 1 depicts a cross-sectional view of an exemplary foam-backed tufted carpet according to various aspects of the present invention;

FIG. 2 depicts a cross-sectional view of an exemplary foam-backed woven carpet according to various aspects of the present invention;

FIG. 3 depicts an exemplary processing line for manufacturing foam backing products according to various aspects of the present invention;

FIG. 4 depicts an exemplary calender unit that may be used in the processing line of FIG. 3;

FIG. 5A depicts a partial perspective view of an exemplary reinforced calendered sheet that is an intermediate product of a process for forming a floor covering, according to various aspects of the present invention;

FIG. 5B depicts a cross-sectional view of a portion of the reinforced calendered sheet of FIG. 5A;

FIG. 6 depicts another exemplary calender unit that may be used in a processing line for manufacturing foam backing products, according to various aspects of the present invention;

FIG. 7 depicts another exemplary calender unit that may be used in a processing line for manufacturing foam backing products, according to various aspects of the present invention;

FIG. 8 depicts a cross-sectional view of another exemplary cushioned floor covering according to various aspects of the present invention;

FIG. 9 depicts a cross-sectional view of yet another exemplary cushioned floor covering according to various aspects of the present invention;

FIG. 10 depicts a cross-sectional view of still another exemplary cushioned floor covering according to various aspects of the present invention;

FIG. 11 depicts another exemplary processing line for manufacturing foam backing products, according to various aspects of the present invention; and

FIG. 12 depicts a cross-sectional view of yet another exemplary cushioned floor covering according to various aspects of the present invention.

### DETAILED DESCRIPTION

Various aspects of the present invention relate to a composition for forming a backing for a floor covering, a floor covering including such a backing, a method of making a backing for a floor covering, and a method of making a floor covering including such a backing. Some of such aspects employ polyvinyl butyral (PVB). Some of such aspects employ recycled materials, virgin (non-recycled) materials, or a combination thereof.

The various aspects of the present invention may be used in connection with numerous types of floor coverings, for example, tufted carpets, woven carpets, tufted carpet tiles, woven carpet tiles, rugs, and flooring tiles. By way of example, and not by way of limitation, carpet is described in detail herein. However, it should be understood that the various aspects of the invention have broad utility with numerous types of floor coverings, such as vinyl, wood, and composite floor coverings.

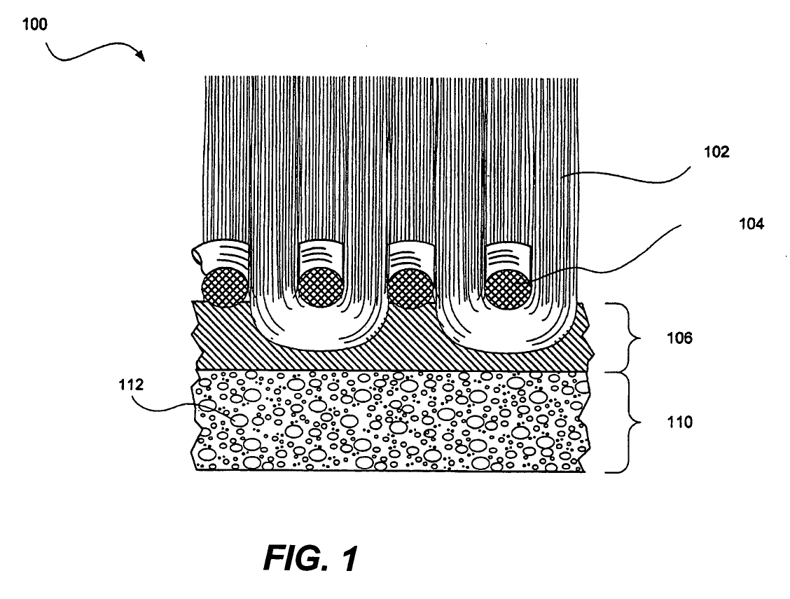

With reference to FIG. 1, an exemplary cushion-backed tufted carpet 100 generally comprises tufted pile yarns 102 that are looped through a primary backing 104. The pile yarns 102 may be cut to form cut pile tufts as illustrated in FIG. 1 or may be left in uncut loops. A pre-coat layer 106 may be used to secure the pile yarns 102 on or within the primary backing 104. A secondary backing 110 may be adhered to the pre-coat layer 106.

The primary backing 104 may be formed using a variety of techniques. In one aspect, the primary backing 104 is a woven material formed by weaving synthetic fibers, such as polypropylene, polyethylene, nylon, polyester, PLA or any combination thereof. In another aspect, the primary backing 104 is a nonwoven fabric, for example, a spunbond, meltblown, or needlepunched material. Any of the materials used to form the primary backing 104, whether woven, nonwoven, or a combination thereof, may be formed from bicomponent fibers having a sheath/core or side by side configuration.

The pre-coat layer 106 may be applied to the textile material using any suitable technique that allows the pre-coat layer to cure, film form, or fuse to the textile material. In one aspect, the pre-coat layer is applied to the carpet using extrusion coating techniques. In another aspect, the pre-coat is applied as a dispersion. In yet another aspect, the pre-coat is applied as a hot melt. However, other processes are contemplated hereby.

The pre-coat layer or backcoating 106 may be formed from any material that secures the pile yarns 102 on or within the primary backing 104. In one aspect, the pre-coat layer 106 comprises a polymeric material. For example, the pre-coat layer 106 may comprise an ethylene/vinyl acetate copolymer, polyvinyl butyral, a polyurethane, polyvinyl chloride, a tackified polyolefin, or any combination thereof. One example of a polyurethane that may be suitable for use with the present invention is DOW 605.01, commercially available from Dow Chemical Company (Midland, Mich.).

The polymer used to form the pre-coat layer may have a glass transition temperature of from about −15° C. to about 10° C. In another aspect, the polymer used to form the pre-coat layer has a glass transition temperature of from about −10° C. to about 5° C. In yet another aspect, the polymer used to form the pre-coat layer has a glass transition temperature of from about −5° C. to about 0° C. Thus, in one particular aspect, the pre-coat layer comprises a polyurethane having a glass transition temperature of from about −5° C. to about 0° C.

The polymer used to form the pre-coat layer may have a tensile strength of from about 1500 to about 5000 psi. In one aspect, the polymer used to form the pre-coat layer has a tensile strength of from about 1700 to about 4000 psi. In yet another aspect, the polymer used to form the pre-coat layer has a tensile strength of from 2000 to about 3500 psi. Thus, in one particular example, the pre-coat layer may comprise a polyurethane having a tensile strength of from 2500 to about 3000, for example, about 2840 psi.

The polymer used to form the pre-coat layer may have an ultimate elongation of from about 700 to about 850%. For instance, the ultimate elongation may be from about 725 to about 825%, or from about 750 to about 800%, for example, about 776%. The polymer used to form the pre-coat layer may have a stress at 100% modulus of from about 200 to about 400 psi, or from about 250 to about 300 psi, for example, 290 psi. Thus, in one particular example, the pre-coat layer may comprise a polyurethane having an ultimate elongation of from about 750 to about 800% and a stress at 100% modulus of from about 250 to about 300 psi.

A polyurethane used in accordance with the present invention may be applied as an aqueous dispersion, or as a molten polymer using, for example, extrusion coating. Where applied as a dispersion, the dispersion may have any suitable solids or non-volatiles content. In one aspect, the polyurethane dispersion has a solids content of from about 60 to about 70%. In another aspect, the polyurethane dispersion has a solids content of from about 50 to about 60%. In another aspect, the polyurethane dispersion has a solids content of from about 40 to about 50%. In another aspect, the polyurethane dispersion has a solids content of from about 30 to about 40%. In another aspect, the polyurethane dispersion has a solids content of from about 20 to about 30%.

Polyvinyl butyral used in accordance with the present invention may be applied as an aqueous dispersion, as a molten polymer using, for example, extrusion coating, or as a tackified hot melt. Where applied as a dispersion, the dispersion may have any suitable solids or non-volatiles content. In one aspect, the polyvinyl butyral dispersion has a solids content of from about 20 to about 80%. In another aspect, the polyvinyl butyral dispersion has a solids content of from about 70 to about 80%. In another aspect, the polyvinyl butyral dispersion has a solids content of from about 60 to about 70%. In another aspect, the polyurethane polyvinyl butyral has a solids content of from about 50 to about 60%. In another aspect, the polyvinyl butyral dispersion has a solids content of from about 40 to about 50%. In another aspect, the polyvinyl butyral dispersion has a solids content of from about 30 to about 40%. In another aspect, the polyvinyl butyral dispersion has a solids content of from about 20 to about 30%.

While various polyurethane and polyvinyl butyral dispersions are provided herein, it will be understood that the optimum level of solids typically depends on the kind of equipment being used and the kind and amount of other components in the formulation. If inorganic fillers and flame retardants are used, they typically are dispersed in the water phase. The more filler needed, the lower the solids that are needed to wet out and disperse the fillers. However, if the solids content is very low, additional drying is needed and the linear speed through the drying oven may need to be decreased to a point where the economics of manufacture are not justified.

The polymeric pre-coat generally may be present in an amount of from about 5 to about 40 wt % based on the weight of the carpet (dry/dry basis). In one aspect, the polymeric pre-coat is present in an amount of from about 10 to about 35 wt % based on the weight of the carpet (dry/dry basis). In another aspect, the polymeric pre-coat is present in an amount of from about 15 to about 30 wt % based on the weight of the carpet (dry/dry basis). In yet another aspect, the polymeric pre-coat is present in an amount of from about 20 to about 25 wt % based on the weight of the carpet (dry/dry basis).

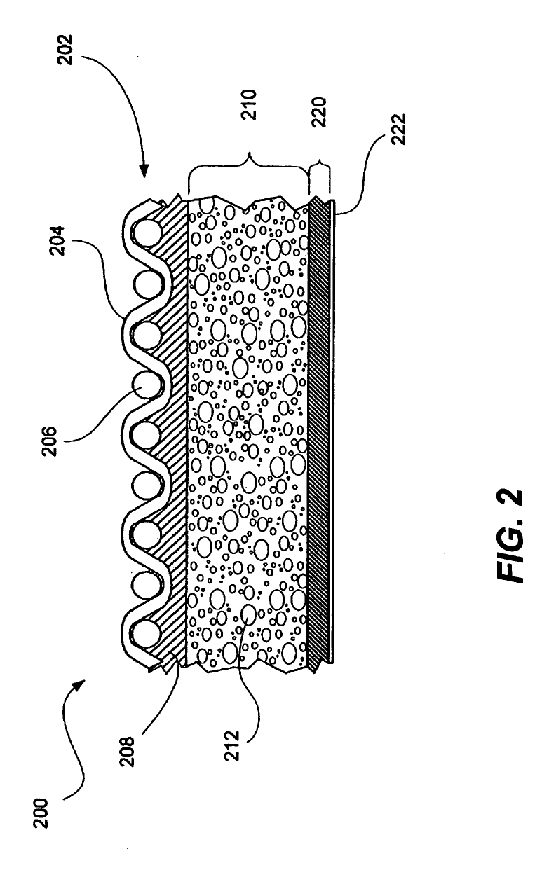

FIG. 2 illustrates an exemplary cushion-backed woven floor covering 200 having a woven carpet layer 202, a back-coating or resin composition layer 208, a backing layer 210 having cells 212 formed therein, and an optional pressure self-release adhesive layer 220 with a releasable liner 222. The woven carpet layer 202 is formed by weaving warp yarns 204 and weft yarns 206 to provide a decorative face surface. The cushioned woven floor covering 200 may be a rolled carpet or cut in the shape of a tile.

The secondary backing (also referred to herein as “backing”) 110, 210 comprises any suitable material, and in some instances, comprises a flexible polymeric matrix. The backing 110, 210 typically serves as a resilient cushion that will compress under an external load and recover when the load is removed. According to various aspects, the backing 110, 210 may be an open cell structure, a partially or substantially closed cell structure, or a closed cell foam. In general, the greater the percentage of closed cells in the structure, the better the cushioning properties of the backing. While the use of foam backings is described in detail herein, it should be understood that non-foam backings also may be used, as will be described in greater detail below.

In the exemplary structure shown in FIGS. 1 and 2, the backing 110, 210 comprises a closed cell foam including a plurality of gas pockets or cells 112, 212. The cells 112, 212 may be voids or may contain air or gases, such as decomposition products of foaming/blowing agents, as will be discussed in detail below. The secondary backing 110, 210 may be bonded or otherwise joined to the adjacent layer or layers 106, 208 using any suitable technique, for example, heat lamination, adhesive, stitching, or otherwise.

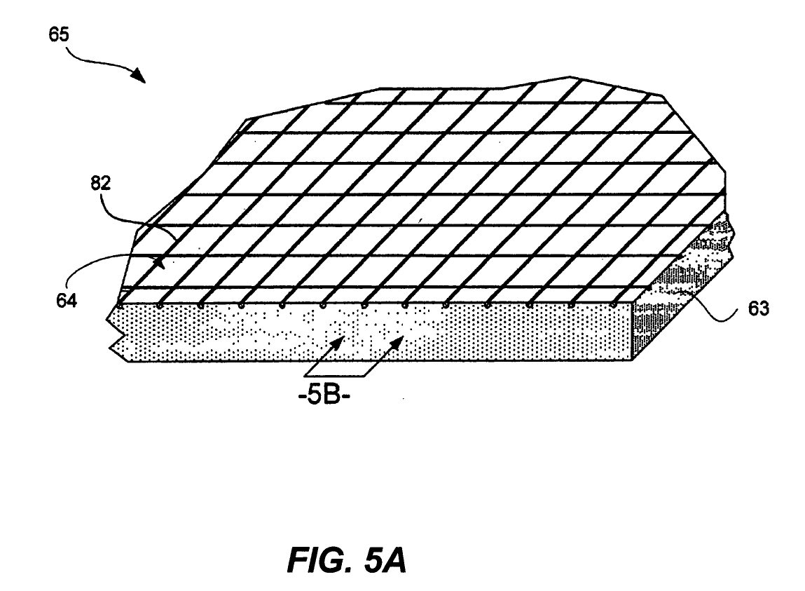

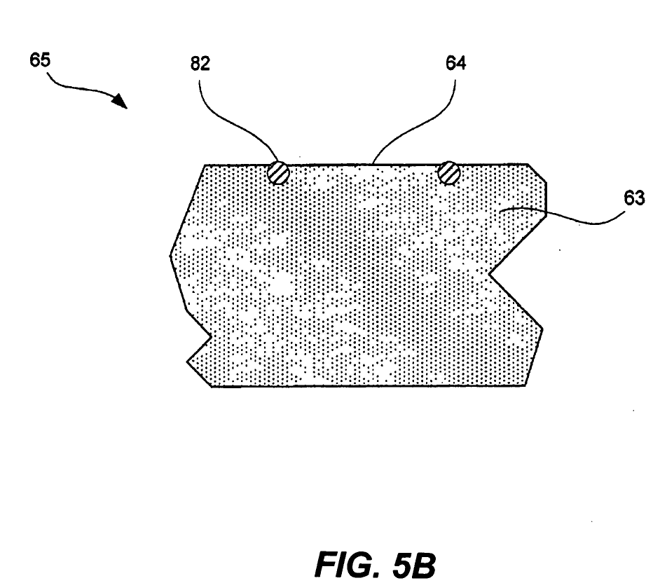

According to one aspect of the invention, the backing 110, 210 comprises polyvinyl butyral (PVB). In another other aspect, the backing 110, 210 comprises PVB foam. The PVB may be recycled from other products or materials, may be virgin, or may be a combination thereof. Optionally, as shown in FIGS. 5A, 5B, 8, 9, 10 and 12, the backing 110, 210 includes a reinforcement material or layer 82. In one aspect, the reinforcement layer is positioned between layer 106, 208 and the backing 110, 210. In another aspect, the reinforcement layer is at least partially embedded in backing 110, 210. In yet another aspect, the reinforcement layer is positioned adjacent the backing on the side distal from layer 106, 208.

In this and other aspects of the present invention, the reinforcing material 82 may be veil, scrim, tissue, felt, nonwoven, or other planar textile fabric that has been created using a weaving, knitting, nonwoven, or other textile manufacturing process. For example, the reinforcing material 82 may be an open weave scrim. As another example, the reinforcing material 82 may be knitted fabric including a weft inserted knit. As yet another example, the reinforcing material 82 may be a cross-laid scrim including an over/under laid scrim or a triaxial laid scrim.

The reinforcing material 82 may be formed from any polymer (e.g. polyester) fibers, or glass fibers, any other suitable material or combination of materials that enhances the strength and/or dimensional stability of the backing and that does not melt or soften in the expansion oven. While the use of reinforced backings is described in detail herein, it will be understood that non-reinforced backings also find broad utility with various other aspects of the present invention.

The invention also contemplates numerous methods of forming a floor covering. In one aspect, the present invention contemplates a floor covering including a foam backing. In another aspect, the invention contemplates a method of forming a carpet backing from recycled materials, virgin materials, or a combination thereof. In yet another aspect, the invention contemplates a method of forming a flooring product that has an emission factor of less than or equal to 1 mg/m²/hr total VOC's as measured using ASTM D-5116-1990 titled “Small-Scale Environmental Chamber Determinations of Organic Emissions from Indoor Materials/Products.”

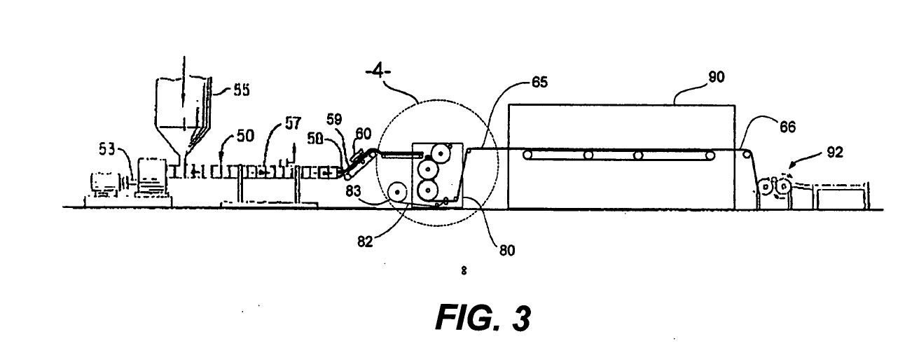

FIG. 3 depicts an exemplary process for manufacturing a foam backing for a floor covering. The composition used to form the backing may be housed in a feeder 55 or other suitable vessel. In one aspect, the composition includes a polymeric material, for example, PVB. The PVB in the composition may comprise waste material, virgin material, or any combination thereof. The waste PVB material may be surplus material produced in other processes in making carpet or other products or may be material that is recycled from other products after use. The PVB component of the backing formulation may include up to 100% by weight waste PVB material, up to 100% by weight virgin PVB material, or any combination of waste and virgin material.

In one aspect, the PVB material may comprise from about 90 to about 100 wt % waste PVB and from 0 to about 10 wt % virgin PVB material. In another aspect, the PVB material may comprise from about 80 to about 90 wt % waste PVB and from about 10 to about 20 wt % virgin PVB material. In another aspect, the PVB material may comprise from about 70 to about 80 wt % waste PVB and from about 20 to about 30 wt % virgin PVB material. In another aspect, the PVB material may comprise from about 60 to about 70 wt % waste PVB and from about 30 to about 40 wt % virgin PVB material. In another aspect, the PVB material may comprise from about 50 to about 60 wt % waste PVB and from about 40 to about 50 wt % virgin PVB material. In yet another aspect, the PVB material may comprise from about 40 to about 50 wt % waste PVB and from about 50 to about 60 wt % virgin PVB material. In yet another aspect, the PVB material may comprise from about 30 to about 40 wt % waste PVB and from about 60 to about 70 wt % virgin PVB material. In still another aspect, the PVB material may comprise from about 30 to about 40 wt % waste PVB and from about 60 to about 70 wt % virgin PVB material. In yet another aspect, the PVB material may comprise from about 20 to about 30 wt % waste PVB and from about 70 to about 80 wt % virgin PVB material. In still another aspect, the PVB material may comprise from about 10 to about 20 wt % waste PVB and from about 80 to about 90 wt % virgin PVB material. In yet another aspect, the PVB material may comprise from 0 to about 10 wt % waste PVB and from about 90 to 100 wt % virgin PVB material.

Waste PVB material may be obtained from a variety of sources for use with various aspects of the present invention. The composition of PVB scrap material may vary depending upon its source. While certain compositions are described in detail herein, it will be understood that numerous other compositions are contemplated hereby.

In one aspect, waste PVB material may be recovered from automobile windshields. An exemplary sample of waste PVB material taken from an automobile windshield may include from:
about 65% to about 90% by weight PVB polymer;
0% to about 35% by weight tetraethylene glycol di-n-heptanoate;
0% to about 35% by weight di-n-hexyl adipate;
0% to about 35% by weight dibutyl sebacate;
0% to about 35% by weight triethylene glycol dihexanoate;
0% to about 35% by weight triethylene glycol di-n-heptanoate;
0% to about 35% by weight triethylene glycol di-2-ethyl-hexanoate;
0% to about 35% by weight tetraethylene glycol di-n-heptanoate; and
0% to about 10% by weight calcium carbonate.

While use of PVB is described in detail herein, it should be understood that various other waste polymeric materials may be used as desired. Examples of such materials include, but are not limited to, one or more of a wide variety of thermoplastic materials, such as polyolefins (e.g., polyethylene and polypropylene), polymers based on vinyl monomers (e.g., vinyl esters, such as vinyl acetate), polymers based on acrylic monomers (e.g., acrylic acid, methyl acrylic acid, esters of these acids, and acrylonitrile), other thermoplastic polymers, blends and copolymers thereof, and any combination thereof. A variety of fibrous polymeric materials also may be included in the mixture.

Other additives also may be included in the composition. Examples of such additives include, but are not limited to, extenders or fillers, blowing agents, processing aids, plasticizers, foaming agents, pigments, antioxidants, antimicrobial agents, cross-linking agents, flame retardants, polymer stabilizers, and the like.

Examples of fillers that may be suitable for use in the backing composition include, but are not limited to, pulverized glass and other glass based materials, metallic and magnetic materials, ATH, fly ash, coal ash, other ash products resulting from energy generation facilities or incineration, carbon black, wollastonite, solid microspheres, hollow microspheres, kaolin, clay-based minerals, bauxite, calcium carbonate, feldspar, nepheline syenite, barium sulfate, titanium dioxide, talc, pyrophyllite, quartz, natural silicas, such as crystalline silica, microcrystalline silica, synthetic silicates, such as calcium silicate, zirconium silicate, and aluminum silicate (including mullite, sillimanite, cyanite, andalusite, and synthetic alkali metal aluminosilicates), microcrystalline novaculite, diatomaceous silica, perlite, synthetic silicas, such as fumed silica and precipitated silicas, antimony oxide, bentonite, mica, vermiculite, zeolite, and combinations of metals with various salts, such as calcium, magnesium, zinc, barium, aluminum combined with oxide, sulfate, borate, phosphate, carbonate, hydroxide, and the like, and any combination thereof.

Other fillers that can be included in the backing formulations include organic materials such as bagasse fillers, recycled paper fillers, coconut hull/fiber fillers, cork fillers, corn cob fillers, cotton-based fillers, gilsonite fillers, nutshell fillers (such as peanuts), rice hull fillers, sisal fillers, hemp fillers, soybean fillers, starch fillers, wood flour fillers, animal fibers such as turkey feather fibers, and any combination thereof.

Likewise, one or more antioxidants or heat stabilizers may be included in the backing formulation to prevent polymer degradation and for other purposes. BHT (2,6-di-t-butyl-p-cresol), phosphite antioxidants, such as TNPP (tris(mono-nonyl phenyl)phosphite), hindered phenolic antioxidants, such as tetrakis[methylene-3(3′,5′-di-tert-butyl-4-hydroxy phenyl)propionate]methane, and thioesters, such as DLTDP, DSTDP, DTDTDP, or any combination thereof, may be used along with other antioxidants or heat stabilizers.

One or more flame retardants also may be included in the backing formulation. Examples of flame retardants that may be suitable include, but are not limited to, ATH, magnesium hydroxide, boron compounds, zinc borate, AOM, halogenated flame retardants, such as deca-DBP, PBDPO, TBBPA, HBCD, TBPA, antimony trioxide, phosphorus compounds, such as red phosphorus, ammonium polyphosphate, triphenyl phosphate, resorcinol diphosphate, bisphenol A diphosphate, 2-ethyl hexyl diphenyl phosphate, nitrogen containing compounds, mica, and any combination thereof.

The backing formulations also may include one or more plasticizers. Examples of plasticizers that may be suitable include, but are not limited to, aromatic diesters such as DINP, DIDP, L9P, DOTP, DBP, DOP, BBP, DHP, aliphatic diesters such as DINA, DIDA, DHA, aromatic sulfonamides such as BSA, aromatic phosphate esters such as TCP and TXP, Alkyl phosphate esters such as TBP and TOF, dialkylether aromatic esters such as DBEP, dialkylether diesters, tricarboxylic esters, polymeric polyester plasticizers, polyglycol diesters, alkyl alkylether diesters such as DBEG, DBEA, DBEEG, and DBEEA, aromatic trimesters such as TOTM and TIOTM, epoxodized esters, epoxidized oils such as ESO, chlorinated hydrocarbons or parrafins, aromatic oils, alkylether monoesters, naphthenic oils, alkylmonoesters, glyceride oils, paraffinic oils, and silicone oils. Linseed oils, citrate plasticizers such as tributyl citrate, process castor oil, raw castor oil, derivatives of castor oil such as butyl ricinoleate, sebacate plasticizers such as dibutyl sebacate, and any combination thereof also may be used.

One or more pigments also may be included in the backing formulation. Examples of pigments that may be suitable include, but are not limited to, carbon black, titanium dioxide, and any combination thereof.

One or more lubricants may be included in the backing formulation. Examples of lubricants include, but are not limited to, derivatives of fatty acids, calcium stearate, zinc stearate, stearic acid, saturated and unsaturated fatty primary monoamides, fatty glicerides such as C14-C18 mono- and di-glycerides, and any combination thereof.

If desired, the backing formulation also may include one or more cross-linking agents such as phenolics, dialdehydes, aziridines, isocyanates, and melamines, or any combination thereof.

Thus, according to one aspect of the present invention, the backing formulation may comprise from about 35 to about 99 wt % PVB (including virgin and/or waste PVB material), about 0 to about 50 wt % filler, from about 0.1 to about 5 wt % blowing agent, and from 0 to about 5 wt % processing aid. According to another aspect of the present invention, the backing formulation may comprise from about 40 to about 80 wt % PVB , from about 20 to about 25 wt % filler, from about 0.5 to about 5 wt % blowing agent, and from 0 to about 1 wt % release aid, such as calcium stearate. According to yet another aspect of the present invention, the backing formulation may comprise from about 50 to about 60 wt % PVB, from about 17 to about 25 wt % plasticizer, from about 0.3 to about 0.8 wt % blowing agent, from about 17 to about 25 wt % calcium carbonate filler, and from about 0.5 to about 0.8 wt % calcium stearate. In one particular aspect, the backing formulation may comprise about 53.7 wt % PVB, about 22.8 wt % plasticizer, about 0.5 wt % blowing agent, about 22.2 wt % calcium carbonate filler, and about 0.8 wt % calcium stearate.

The polymeric material and any additives optionally are mixed with a blowing agent and/or other cell-producing material. The blowing agent may be added in liquid, powder, or pellet form. The temperature at which the blowing agent releases gas may vary depending on the blowing agent selected. Examples of blowing agents that may be suitable for use with the present invention include, but are not limited to, azodicarbonamide (ADC), expandable microspheres, OBSH (4-oxy bis benzene sulfonyl hydrazide), p-toluene sulfonyl semicarbizide, sodium bicarbonate, citric acid, and the like, and any combination thereof.

One particular example of an ADC blowing agent that may be suitable for use with various aspects of the present invention is Blo-Foam PMA 50 pellets, commercially available from Rit-Chem Company, Inc. (Pleasantville, N.Y.). PMA 50 is heat-activated and includes about 50% azo blowing agent (ADC 1200 grade) and 50% PVC. PMA 50 is therefore 50% active. The average particle size (i.e., the average diameter of the particle) is from about 3 to about 11 microns. The PMA 50 may be added in an amount of from about 0.1% to about 5% (wt/wt) based on the percent “active” azodicarbonamide. For example, the PMA 50 may be added in an amount of from about 0.5 to about 2.0 wt % (about 0.25% to about 1.0% active) of the mixture. The decomposition temperature of the active azo ingredient, ADC 1200, is approximately 195° C. to 220° C. (383° F. to 428° F.). However, the effective decomposition temperature of the activated azodicarbonamide of the pellet ranges from about 175° C. to 185° C. (347° F. to 365° F.).

The gas volume resulting from decomposition of azodicarbonamide may be from about 85 to about 115 ml/gram of azodicarbonamide. When the blowing agent is heated to its activation temperature, it decomposes and produces various gases including, for example, nitrogen, carbon monoxide, carbon dioxide, and ammonia. These gases expand and produce cells or gas pockets in the material. When the material hardens or cures, permanent bubbles, cavities, or voids are established.

While the use of azo blowing agents is described in detail herein, it will be understood that other blowing agents having decomposition temperatures as low as about 163° C. (325° F.) may be used as long as the temperature during processing can be kept below the decomposition temperature.

The activation or decomposition rate of any of the various blowing agents can be altered through the use of an activator. Suitable activators for azodicarbonamide blowing agents include, but are not limited to, transition metal salts, particularly those of lead, cadmium, and zinc or organometallic compounds, such as zinc stearate and barium stearate. Although dependent on the composition and activation characteristics of the blowing agent, activators typically are added at approximately a 1 to 1 ratio of activator to blowing agent.

If desired, one or more cell-producing materials may be added to the mixture in addition to, or as a substitute for, a chemical blowing agent. For example, expandable hollow microspheres, such as those produced by Expancel, Inc., may be added to the polymeric material. These microspheres are formed as spherical polymer shells encapsulating a gas. When heated, the shell softens and the gas pressure inside the shell increases. As a result, the microsphere expands. When dispersed in an uncured backing layer, the effect of the expandable microspheres is similar to that of a blowing agent. When the backing layer is heated, the microspheres expand creating cells or voids in the polymeric material. These cells or voids are established permanently as the backing layer material is cured or hardens.

Where a non-foam backing is used, a blowing agent is not needed in the composition. Additionally, more filler may be used if desired, for example, from about 50 to about 60 wt %. Thus, according to one aspect of the present invention, the backing formulation may comprise from about 35 to about 99 wt % PVB (including virgin and/or waste PVB material), about 0 to about 70 wt % filler, and from 0 to about 5 wt % processing aid. According to another aspect of the present invention, the backing formulation may comprise from about 40 to about 65 wt % PVB from about 40 to about 65 wt % filler, and from 0 to about 1 wt % release aid, such as calcium stearate. According to yet another aspect of the present invention, the backing formulation may comprise from about 30 to about 40 wt % PVB, from about 11 to about 17 wt % plasticizer, from about 45 to about 55 wt % calcium carbonate filler, and from about 0.5 to about 1.0 wt % calcium stearate. In one particular aspect, the backing formulation may comprise about 34.7 wt % PVB, about 14.9 wt % plasticizer, about 49.5 wt % calcium carbonate filler, and about 0.9 wt % calcium stearate.

The polymeric materials and the optional blowing agent and/or cell-producing materials then are heated to melt and blend the components. In one aspect, the components include recycled and/or virgin PVB, calcium carbonate filler, blowing agent concentrate (a masterbatch of azodicarbonamide and polyolefin), and a calcium stearate calender release aid. The blending may be accomplished through the use of any suitable batch mixer (e.g., a Banbury® mixer), extruder, FCM (Farrell Continuous Mixer), or other mixing device.

In the exemplary process illustrated in FIG. 3, an extruder 50 is used to produce a molten blend of the various components. Examples of extruders that may be suitable are Model 2DS-K 57M32 and ZSK-170 M 175010G, both commercially available from Werner & Pfleiderer (Germany). A metal scavenging station, such as a magnet (not shown), may be located at the entrance of the feeder 55. A controller 53 is provided to ensure that the extruder 50 and feeder 55 act cooperatively to maintain a constant feed condition throughout the conveying zone to one or more kneading zones. The materials pass through an extruder barrel 57 having a degassing or a vacuum zone including at least one vent to assist with the removal of volatile compounds, including water and VOC's. Additional vents are provided throughout the extruder to continue to remove volatile compounds from the extrudate.

The materials then are passed through a pumping zone, which forces the materials through a die 58. The pumping zone is used to develop sufficient throughput without creating undesirable back pressure and torque in the preceding zones or on the thrust bearings of the extruder 50.

The extruder 50 is operated at a temperature high enough to melt the non-fibrous thermoplastic polymer materials in the material mixture and produce a uniform, blended extrudate 59. However, if a blowing agent is included in the material mixture, the temperature in the extruder 50 generally is kept below the decomposition temperature of the blowing agent to ensure that the blowing agent is not activated during extrusion. For example, when an azodicarbonamide blowing agent is used, the extruder 50 generally is operated to achieve a melt temperature of from about 200° F. to about 380° F. as the extrudate 59 exits the die 58. Thus, for example, the temperature at the die head may be about 325° F.

Upon exit from the die 58, the blended extrudate 59 may be passed through a metal detector 60 and fed into a calendering unit 80, which forms the blended material of the extrudate into a uniform sheet or rope. The dimensions of the extrudate 59 may be established to provide ease of handling and feeding of the calendering unit 80. In an illustrative embodiment, the extrudate 59 has a substantially circular cross-section with a diameter of about 1 to about 5 in., for example about 2 in. The material is calendered at a temperature of from about 190° F. to 350° F., for example, at about 325° F., and maintained at the elevated temperature until the material exits the calender, thereby further removing VOCs.

Where a non-foamed backing is used, and therefore no blowing agent is included in the composition, the extruder may be operated at a higher temperature as needed or desired to drive off additional VOC's.

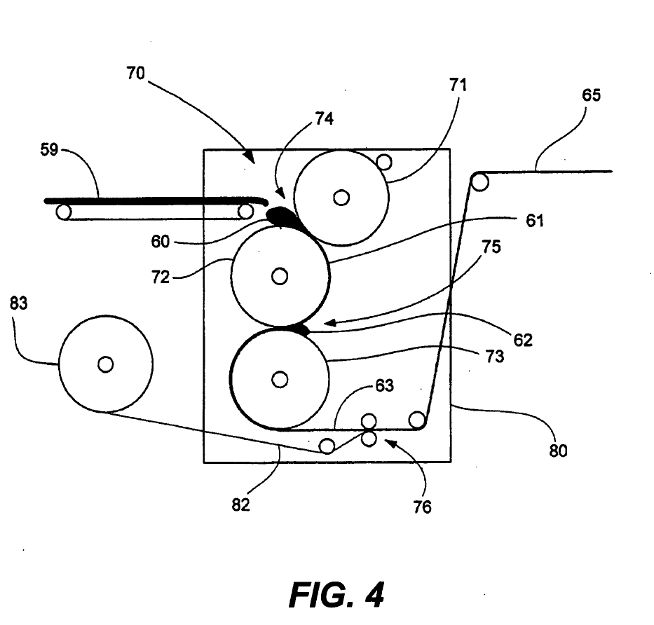

A variety of calender types may be used in the methods disclosed herein. As shown in FIG. 4, a standard three cylinder inverted J-stack calender 70 may be used. The extrudate 59 is fed to a first nip 74 between first and second counter-rotating heated rolls 71, 72. The extruder 50 provides a continuous feed of material to the calender 70 to maintain a constant reservoir or bank of material 60 at the first nip 74. An intermediate sheet 61 is formed as the material passes through the gap between the first and second rolls 71, 72.

The first and second rolls 71, 72 are rotated at different speeds so the bank 60 of blended material ahead of the first nip 74 is rolled constantly and kneaded in the direction of the rotating rolls 71, 72. In an illustrative example where the rolls of the calender have a diameter of about 24 inches, the second roll 72 may operate at about 5 rpm while the first roll 71 operates at about 4.5 rpm.

The intermediate sheet 61 is passed to a second nip 75 formed between the second roll 72 and a third heated roll 73. The third roll 73 operates at a faster speed than the second roll 72. In the illustrative example where the second roll 72 operates at about 5 rpm, the third roll 73 may operate at about 6 rpm. A second bank of material 62 collects ahead of the second nip 75 and, like the first bank 60, is rolled constantly in the direction of the rotating rolls. Shear and friction in the second bank 62 and the drawing of the intermediate sheet 61 between the second and third rolls 72, 73 tend to align any fibrous materials present. The intermediate sheet 61 is thinned and widened as it passes through the second nip 75 to form a final calendered sheet 63.

Optionally, the sheet 63 is passed between a pair of press rolls 76, where it is pressed with a sheet of reinforcing material 82 supplied from a reinforcing material roll 83 to form a reinforced sheet 65. The reinforcing material 82 can be an open weave scrim material that retains its strength at the temperatures used to activate the blowing agent. Suitable materials include woven polyester and glass scrim. Non-woven or tissue type materials also may be used, but such materials may necessitate the use of an additional adhesive layer when the final backing layer is bonded to the carpet back.

As shown in FIGS. 5A and 5B, the reinforcing material 82 may be embedded substantially within the calendered sheet 63, although a portion of the reinforcing material 82 may be exposed or even extend above the surface 64. The embedded reinforcing material 82 helps to provide dimensional stability to the reinforced sheet 65 and prevent the buildup of residual stresses in the material that can cause non-uniform expansion when the void-producing material is activated.

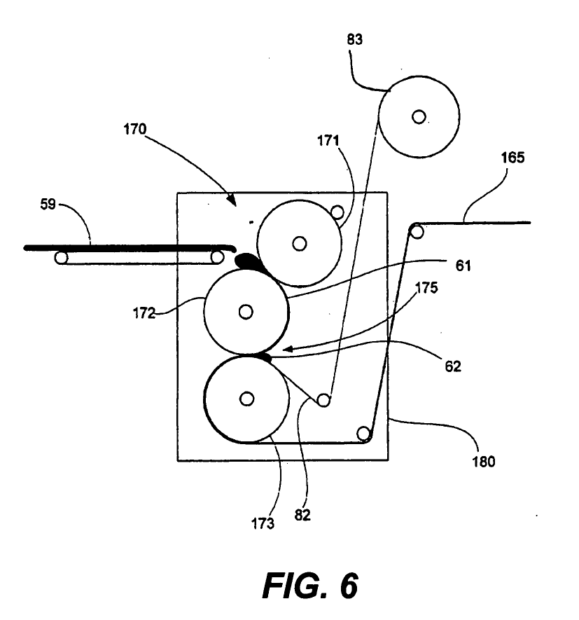

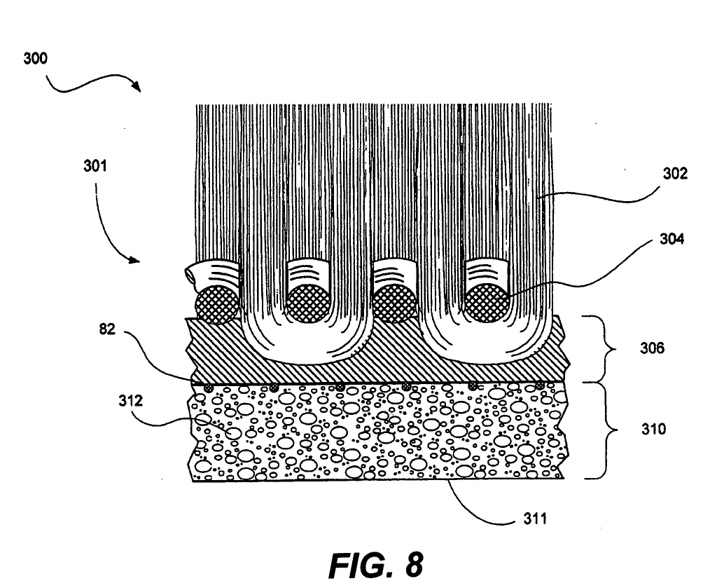

An alternate calendering process is illustrated in FIG. 6. The calendering unit 180 uses a calender 170 having first, second, and third rolls 171, 172, 173 to process the blended extrudate 59. Each roll rotates at a different speed. The calendering unit 180 is configured so that the reinforcing material 82, where used, is drawn through a nip 175 between the second and third rolls 172, 173 along with the intermediate sheet 61. The reinforcing material 82 may be fed into the nip 175 so that it passes between the surface of the third roll 173 and the material bank 62 that is maintained ahead of the nip 175. The output is a reinforced calendered sheet 165 in which the reinforcing material 82 is embedded at least partially in the polymeric material. The optionally reinforced calendered sheet 165 then is passed to an oven 90 (FIG. 3) to produce the foam backing 310 (FIG. 8).

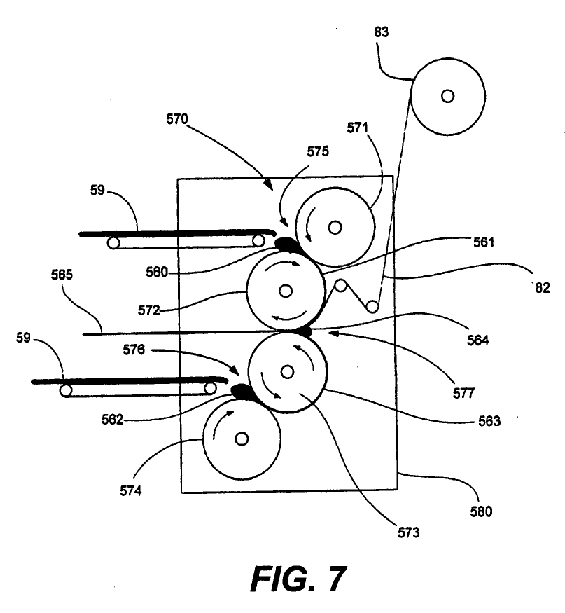

Yet another alternate calendering process is depicted in FIG. 7. The calender unit 580 includes a calender 570 having four heated rolls 571, 572, 573, 574. The extrudate 59 is fed to the calender 570 at a first nip 575 between the first and second counter-rotating heated rolls 571, 572 and at a second nip 576 between the third and fourth counter-rotating heated rolls 573, 574. The first and fourth rolls 571, 574 rotate at a first speed and the second and third rolls 572, 573 rotate at a second speed greater than the first speed. A first bank of material 560 is maintained at the first nip 575 and a second bank of material 562 is maintained at the second nip 576. The first and fourth rolls 571, 574 are rotated at different speeds from the second and third rolls 572, 573 so that the banks 560, 562 of blended material are rolled constantly and kneaded in the machine direction. A first intermediate sheet 561 is formed as the material passes through the gap between the first and second rolls 571, 572 and a second intermediate sheet 563 is formed as the material passes through the gap between the third and fourth rolls 573, 574.

The first and second intermediate sheets 561, 563 are pressed together by passing them both through a third nip 577 between the second and third rolls 572, 573. A reinforcing material 82 is fed continuously from a supply roll 83 to the third nip 577 between the first and second intermediate sheets 561, 563. The result is a reinforced calendered sheet 565 in which the reinforcing material is embedded substantially or completely. The calendered sheet 565 then can be cooled and rolled or passed to an oven where it is expanded to form reinforced foam backing.

In this aspect, because the calender 570 is fed continuously to two places, additional changes to the processing line may be required. These may include configuring the line to divide the extrudate 59 before delivery to the calender 570 or providing two separate extruders 50. It will be understood that using multiple extruders would reduce the required throughput of each extruder 50 since the total amount of extruded material required for the foam backing 510 would be about the same as for the other foam backing embodiments. It also will be understood that the composition in each extruder may be the same or may differ. Thus, for example, a first extruder composition may include a particular polymer(s) and/or additive(s), and the second extruder may include the same or different polymer(s) and/or additive(s). In doing so, the properties of the backing can be adjusted or enhanced for a particular product application. It also will be understood that the reinforcing material may be positioned in any manner throughout the thickness of the backing. Thus, for example, the reinforcing material may be proximal one side of the backing or the other, or may be positioned equidistant or substantially equidistant from both sides, as desired.

As an alternative to calendering, the sheet of polymeric material may be formed using a sheet, slot, or film die attachment in combination with the extruder or may be formed using a second extruder with a sheet die. If a second extruder is used, the operating temperature of the second extruder also is kept below the decomposition temperature of the blowing agent.

Returning to FIG. 3, the reinforced sheet 65 optionally may be cooled at a cooling station and formed into rolls, which then can be transferred to another processing line or stored.

Alternatively, according to one aspect of the present invention, the unexpanded reinforced sheet 65 is transported from the calendering unit 80 to an oven 90, where the reinforced sheet 65 is heated. If a chemical blowing agent is used, the sheet 65 is heated to a temperature above the decomposition temperature of the blowing agent. The reinforced sheet 65 may be supported on and transported through the oven 90 by a conveyer 91. The reinforced sheet 65 may be passed through the oven 90 with the reinforcing material 82 facing away from or towards the conveyer 90.

The oven 90 generally is configured to assure uniform heating and airflow over the entire reinforced sheet 65. The oven temperature typically is from about 300° F. to about 450° F., for example, about 420° F. The airflow in the oven is maintained at a level sufficient to draw VOC's from the sheet. As the temperature in the reinforced sheet 65 exceeds the decomposition temperature of the blowing agent, gas pockets are formed that reduce the density and increase the thickness of the reinforced sheet 65, thereby producing a reinforced foam backing 66. Using a blowing agent level of approximately 1.5% (0.75% active) by weight of the backing formulation, the foam backing 66 can reach a post-activation thickness that is 2 to 4 times the thickness of the unexpanded sheet 65. In a typical carpet backing, this corresponds to a density reduction from approximately 85 lbs/ft³ at 50 mils thickness to approximately 27 lbs/ft³ at 150 mils thickness. Similar expansion may be accomplished using expandable microspheres. The reinforced foam backing may have a thickness of from about 75 to about 200 mils. In another aspect, the backing may have a thickness of from about 80 to about 160 mils. In yet another aspect, the backing may have a thickness of from about 90 to about 100 mils.

Where a non-foamed backing is used, the oven may be maintained at a temperature of from about 275° F. to about 375° F., for example, about 300° F. to remove VOC's.

After exiting the oven 90, the reinforced backing 66 may be cooled and accumulated into rolls at an accumulation station 92. The rolls may be stored for later processing. Alternatively, the rolls of backing 66 may be used as a separate pad or cushion for placement underneath carpeting. Alternatively still, the rolls may be passed directly to a finishing station (not shown) where the backing is adhered to a pre-finished carpet product. The pre-finished carpet may be formed according to numerous processes. In one exemplary process, nylon yarns are tufted into a primary backing, thereby forming a textile fabric. A polyurethane dispersion pre-coat then is applied to the backside of this fabric to lock in the stitches and to create a surface to bond to the foamed backing. The precoated carpet then is dried in an oven to remove the water in the polyurethane dispersion and form the precoat into a film. The resulting carpet roll stock is wound into a roll for later processing by the finishing station (not shown).

The carpet roll stock and backing are aligned and subjected to heat, for example, infrared heat, to cause the materials to adhere together. The materials may be pressed together and compacted using nip rollers. The heat may be infrared heat or any other suitable source of heat maintained at a temperature of from about 900° F. to about 1000° F., for example 950° F. This elevated temperature further removes VOC's from the backing.

In one aspect, the resulting floor covering has a total volatile organic compound emission factor of less than about 1 mg/m²/hr as measured according to ASTM D-5116-1990. In another aspect, the floor covering has a total volatile organic compound emission factor of less than about 0.75 mg/m²/hr as measured according to ASTM D-5116-1990. In yet another aspect, the floor covering has a total volatile organic compound emission factor of less than about 0.5 mg/m²/hr as measured according to ASTM D-5116-1990. In still another aspect, the floor covering has a total volatile organic compound emission factor of less than about 0.375 mg/m²/hr as measured according to ASTM D-5116-1990.

Optionally, an adhesive is applied to the back of the backing, opposite the pre-finished carpet. In one aspect, the adhesive is an acrylic polymer. The adhesive may be applied in any of numerous manners and, in some instances, is applied using a roll coater. The adhesive on the carpet then is dried to form a tacky surface. Any additional VOC's are removed further by heating in the oven. A release liner is applied over the adhesive and the carpet is cooled and rolled up for shipment. If no adhesive is to be applied, the finished carpet is ready for shipment.

FIG. 8 illustrates a floor covering product 300 having a reinforced foam backing 310 produced using the exemplary process described above. The floor covering product 300 comprises a tufted carpet 301 having looped pile yarns 302 tufted or looped through a primary backing 304 and extending upwardly therefrom. A polymeric pre-coat or backcoating 306 is used to fix the pile yarns 302 in place in the primary backing 304. The reinforced foam backing 310 includes a foam layer 311 comprising a plurality of substantially uniformly distributed closed cells 312. A partially or entirely open cell foam backing also may be used. The reinforced foam backing 310 also includes a reinforcing layer or material 82 at least partially embedded in the upper surface of the foam layer 311. The reinforcing material 310 may be any material as described above.

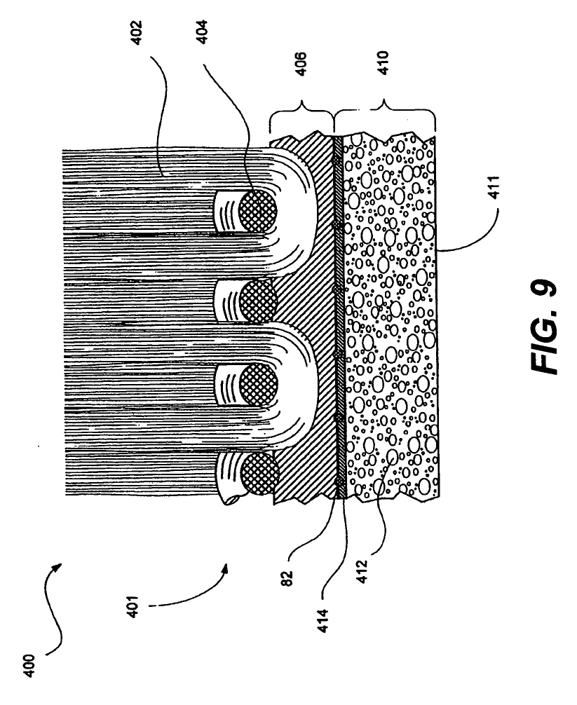

Another floor covering having a reinforced foam backing layer is shown in FIG. 9. The floor covering 400 comprises a tufted carpet 401 having looped pile yarns 402 tufted or looped through a primary backing 404 and extending upwardly therefrom. A polymeric pre-coat or backcoating 406 is used to secure the pile yarns 402 to the primary backing 404. The reinforced foam backing 410 includes a foam layer 411 comprising a plurality of substantially uniformly distributed closed cells 412. A substantially or entirely open cell foam backing also may be used. The foam layer 411 may comprise any suitable material or combination of materials as described above.

The reinforced foam backing 410 also may comprise a reinforcing material 82 adhered to the upper surface of the foam layer 411 using an adhesive layer 414. The reinforcing material 82 can be an open weave fabric or scrim formed from woven polyester or glass fibers, or any other material as described above. The adhesive generally is selected for its ability to retain structural integrity and adherence to both the reinforcing material and the calendered sheet when subjected to the temperatures needed to activate the blowing agent. The adhesive generally is compatible with both the backing polymers and the pre-coat polymer to provide a suitable bond. In one aspect, the adhesive is RS-3120, commercially available from Solutia Inc. (Springfield, Mass.). The adhesive may be applied in an amount of, for example, from about 1 to about 5 ounces per square yard on a dry/dry basis.

The reinforced foam backing 410 may be manufactured using the process associated with the processing line shown in FIG. 3 but with the additional step of applying the adhesive layer 414 to the calendered sheet 63 prior to application of the reinforcing material 82. This method may be used if the calendered sheet 63 has been cooled and is no longer soft enough to embed the reinforcing material into the surface of the sheet. The combined adhesive layer 414 and reinforcing material 82 serve to maintain the dimensional stability of the reinforced calendered sheet through the expansion process to produce a substantially uniform reinforced foam backing 410. The adhesive used to attach the reinforcing material 82 also may be used to adhere the reinforced foam backing 410 to the pre-coat 406 using the heat lamination process discussed above. Alternatively, an additional adhesive may be used.

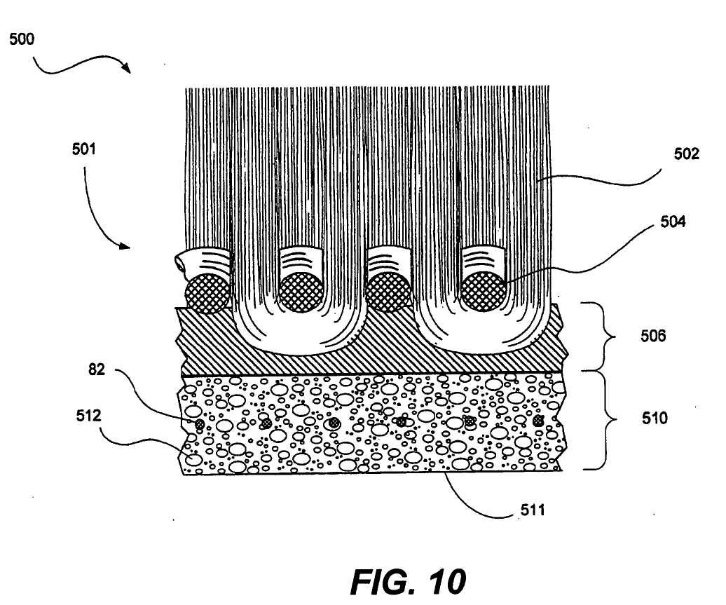

Yet another exemplary floor covering is illustrated in FIG. 10. The floor covering 500 comprises a tufted carpet 501 having looped pile yarns 502 tufted or looped through a primary backing 504 and extending upwardly therefrom. A polymeric pre-coat or backcoating 506 is used to secure the pile yarns 502 to the primary backing 504. The reinforced foam backing 510 includes a foam layer 511 comprising a plurality of substantially uniformly distributed closed cells 512. A substantially or entirely open cell foam backing also may be used. The foam layer 511 may comprise the previously discussed scrap materials such as the previously described waste polymeric carpet or automotive windshield interlayer materials. These materials may include fibrous aliphatic polyamide polymer materials that are in at least partial alignment. The reinforced foam backing 510 may comprise a reinforcing material 82 entirely embedded within the foam layer 511. The reinforcing material 82 may be any suitable material, as described above.

It will be understood that any of the various reinforced foam backings formed in accordance with the present invention also may be applied to a woven floor covering of the type depicted in FIG. 2. Both the tufted floor covering and a similarly backed woven floor covering may be produced as roll goods or may be used to produce carpet tiles. In either case, a pressure sensitive adhesive layer and, if desired, a release cover may be applied to the underside of the reinforced foam backing.

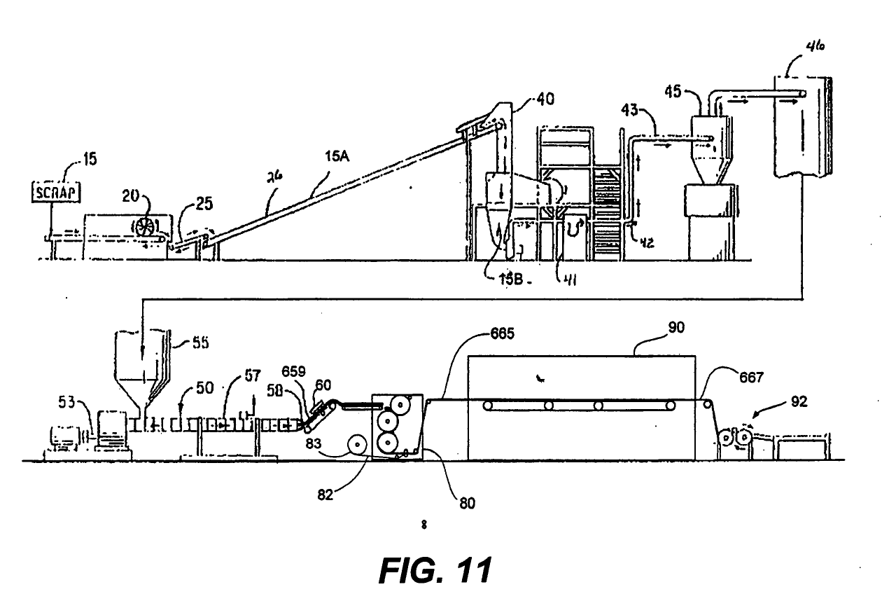

According to another aspect of the present invention, a floor covering backing including other waste polymeric materials is provided. A process for forming such a backing is depicted in FIG. 11. Some of the waste polymeric material may include thermoplastic materials generated during the manufacture and/or disposal of various floor coverings. Virgin and/or recycled PVB also may be included. Such material may be processed as follows, or may be delivered directly to the extruder as described above.

Other thermoplastic materials that may be present include aliphatic polyamides and/or other fibrous materials, polyolefins (e.g., polyethylene and polypropylene), polymers based on vinyl monomers (e.g., vinyl esters, such as vinyl acetate, and vinyl acetals), polymers based on acrylic monomers (e.g., acrylic acid, methyl acrylic acid, esters of these acids, and acrylonitrile), other thermoplastic polymers, and blends and copolymers thereof. Other materials that are typically present in the scrap material include any of various plasticizers, inorganic fillers, inorganic flame retardants, organic flame retardants, fiberglass, blowing agents, polyester, pigments, stabilizers, oils and processing aids and antisoiling or antistaining chemicals.

The fibrous materials that may be present in the material in an amount of from 0 to about 40 wt % of the total amount of material, for example, about 12 wt % of the total amount of material. The fibrous materials are believed to add strength and stability to the final recycled backing product.

The waste polymeric material may include aliphatic polyamide polymers. As used herein, the term “aliphatic polyamide polymer” refers to, but is not limited to, any long-chain polymeric or copolymeric amide that has recurring amide groups as an integral part of the main polymer or copolymer chain, which may be in the form of a fiber. Examples of aliphatic polyamides can include wool, nylon 6 or poly (omega-caprolactam); nylon 66 or poly (hexamethylenedia mine-adipic acid) amide; poly (hexamethylenediamine-sebacic acid) amide or nylon 610; and the like. When present in fibrous form in the final manufactured product, alignment of the aliphatic polyamide polymers in the product material may add to the strength of the material, particularly the tear strength of the material lateral to the direction of fiber alignment.

It will be understood that the waste polymeric material may be provided as a pellet, chip, tiles, sheet, strips, or in any other form. In some instances, it may be necessary or advantageous to subject the polymeric material to one or more processes that further reduce the size of the waste material. In other instances, the waste polymeric material may be suitable for direct feeding into the extruder.

Viewing FIG. 11, waste polymeric material (“scrap”) 15 is delivered to a guillotine chopper 20. The guillotine chopper 20 may be any conventional guillotine chopper that coarsely chops the waste polymer material into ¾ to 1 inch in width portions. One example of a suitable guillotine chopper is Model CT-60 available from Pieret, Inc. The chopped mixture 15A is transported, for example, via conveyer belts 25 and 26 to a granulator 40, which grinds the one inch portions into fragments at least an order of magnitude smaller than the original size of waste polymeric material. Typically, this may be less than about ⅜ in. in width. One example of a suitable granulator is Model 24-1 available from Cumberland Company.

The granulated material 15B is typically in the form of a fluffy, fibrous material and solid polymeric particles. The granulated mixture 15B may be transported to a densifier or plastcompactor 41, which forms the granulated mixture into a densified material 42. The densifier 41 can be designed to heat, melt, and form or compact the granulated mixture 15B into semi-uniform pellets. These pellets increase the throughput of the extruder 50 and allow the extruder 50 to produce a more uniform blend of molten recycled material. One exemplary densifier that may be suitable for use with the present invention is a Plastcompactor Pelletizer Model No. CV50, commercially available from HERBOLD ZERKLEINERUNGSTECHNIK GmbH, has an approximate volume densification ratio of 2:1 (original granulated material to densified material volume). The use of the densifier 41 can increase the output of the extruder 50 from approximately 1,000 lbs per hour to approximately 4,000 to 6,000 lbs per hour.

Optionally, if a finer material is required, the densified, pelletized material 42 is sent via a conveyor to a cryogenic grinder (not shown) that uses liquid nitrogen to freeze and pulverize the densified, pelletized material to form a hard cryogenically ground material that is fed into the extruder 50. The cryoground material may be made up of particles having a diameter of from about 0.01 to about 0.20 in. These particles may be screened to remove particles larger than a desired limit. Cryogenic grinding also may be used as an alternative to or as a precedent step to the densification of the granulated material 15B. In such instances, the granulated mixture 15B can be sent via a conveyor 26 to a cryogenic grinder (not shown). The cryogenically ground material then may be sent either to the densifier 41 or directly to the extruder 50.

The densified material and/or cryogenically ground material 42 may be transported via air in a conduit 43 to a Gaylord loading station 45 and/or to a silo 46. If desired, fines, dust and/or fibers may be removed and separated from the densified material and/or cryogenically ground material 42 using an elutriation process or other suitable process. The densified material and/or cryogenically ground material 42 then is conveyed to the extruder feeder 55 which feeds the extruder 50. Additional recycled material, such as granulated waste thermoplastics, may be added to the waste polymeric material 42 in the hopper. Virgin material also may be added.

The process continues in a manner similar to that discussed in connection with FIG. 3. It will be understood that various other processing times, temperatures, line speeds, and other conditions may vary depending on the composition of the polymeric materials used to form the floor covering backing and the quantity of VOC's to be removed. Thus, while certain processing conditions are described herein, other conditions are contemplated hereby.

Still viewing FIG. 11, after exiting the oven 90, the foam backing 667 may be cooled and accumulated into rolls at an accumulation station 92. The rolls of reinforced foam backing 667 then may be stored or transported to a carpet finishing line where the backing is adhered to a carpet product. In this and other aspects, the reinforced foam backing 667 also may be used as a separate pad or cushion for placement underneath carpeting.

Alternatively, after cooling, the reinforced foam backing 667 may be passed directly to a finishing station (not shown) where it is adhered to the carpet product. To bond the reinforced foam backing to a pre-finished carpet having a polymeric pre-coat layer, heat may be applied to the reinforced side of the reinforced foam backing and to the pre-coat layer of the carpet. The reinforced side of the reinforced foam backing then is contacted with the pre-coat layer and the two layers are pressed together.

In one aspect, the resulting floor covering has a total volatile organic compound emission factor of less than about 1 mg/m²/hr as measured according to ASTM D-5116-1990. In another aspect, the floor covering has a total volatile organic compound emission factor of less than about 0.75 mg/m²/hr as measured according to ASTM D-5116-1990. In yet another aspect, the floor covering has a total volatile organic compound emission factor of less than about 0.5 mg/m²/hr as measured according to ASTM D-5116-1990. In still another aspect, the floor covering has a total volatile organic compound emission factor of less than about 0.375 mg/m²/hr as measured according to ASTM D-5116-1990.

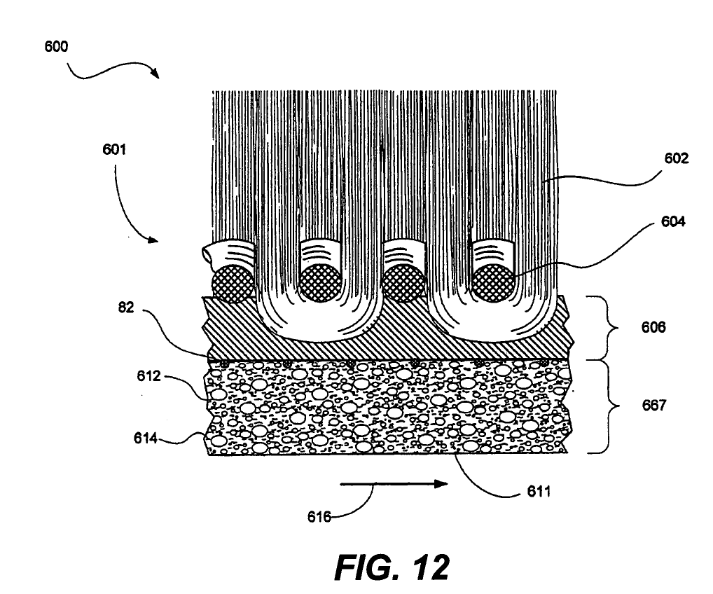

FIG. 12 illustrates an exemplary floor covering product 600 having a reinforced foam backing 667 formed from according to the exemplary process described above. The floor covering product 600 comprises a tufted carpet 601 having looped pile yarns 602 tufted or looped through a primary backing 604 and extending upwardly therefrom. A polymeric pre-coat or backcoating 606 is used to fix the pile yarns 602 in place in the primary backing 604. The reinforced foam backing 667 includes a foam layer 611 that may comprise one or more of the previously discussed scrap materials, such as waste polymeric carpet materials or waste safety glass interlayer. The foam layer also comprises a plurality of substantially uniformly distributed closed cells 612. However, it will be understood that a foam layer comprising open cells also may be used.

The foam layer 611 optionally includes fibrous materials 614 that have retained their fibrous form. The fibers 614 remain, at least to some degree, aligned in a direction corresponding to the machine direction 616, despite the presence of the cells 612.

It will be understood that the backing layer 667 also may be used with a woven floor covering of the type depicted in FIGS. 2, 8, and 9. Both the tufted floor covering and a similarly backed woven floor covering may be produced as roll goods or may be used to produce carpet tiles. In either case, a pressure self-release adhesive layer may be applied to the underside of the reinforced foam backing. If an adhesive layer is applied, a release liner may be applied over the adhesive.

### EXAMPLES

PVB chips and various carpet samples having a PVB backing were evaluated to determine the level of VOC's present. The PVB chip (Sample 1) was obtained from Dlubak Glass Company. A description the various carpet samples (Samples 2-5) is provided in Table 1.

TABLE 1

| | Sample 2 | Sample 3 | Sample 4 | Sample 5 |
|---|---|---|---|---|
| Carpet face style name | Kente | Unknown | Calypso | Luminaire |
| Gauge | 1/12 | Unknown | 1/12 | 1/10 |
| Pile Height Average | 0.187 | Unknown | 0.187 | 0.187 |
| (in.) (ASTM D-148, | | | | |
| sect. 12) | | | | |
| Fiber system | 100% | Unknown | TDX | Antron |
| | DuPont | | nylon | Lumena- |
| | Lumena- | | | Reg. |
| | Reg. Nylon | | | Sol. dyed |
| | 6,6 | | | nylon 6,6 |
| Pile Units per inch | 8.0 | Unknown | 6.9 | 11.0 |
| (ASTM D-148, | | | | |
| sect. 12) | | | | |
| Nylon basis wt (osy) | 20.0 | Unknown | 22.0 | 26 |
| Primary backing basis | 3.2 | 3.2 | 3.2 | 3.2 |
| wt | | | | |
| Polymer pre-coat | Dow 605.01 PUD compounded with additives | | | |
| Pre-coat basis wt (dry) | 22 | 22 | 22 | 22 |
| (osy) | | | | |
| Backing basis wt (osy) | 43.4 | 43.4 | 43.4 | 43.4 |
| Total basis wt (osy) | 88.6 | Unknown | 90.6 | 94.6 |

Samples 1-3 and 5 were evaluated according to ASTM D-5116-1990. Sample 4 was evaluated according to California 01350 guidelines. Thus, some data is not available, as indicated by “NA”. The results are provided in Table 2. A value indicated as “BDL” was beyond the detection limit for the compound. “NT” means that the sample was not tested for the particular compound. All values are measured in μg/m²/h. It should be noted that the amount of PVB in Sample 1 was about 10 times greater than the amount of PVB in Samples 2-5.

TABLE 2

| | | | Sam- | | | |
|---|---|---|---|---|---|---|
| | CRI | Sample | ple | Sample | Sample | Sample |
| Compound | Limit | 1 | 2 | 3 | 4 | 5 |
| Acetaldehyde | 20 | BDL | NT | NT | Pass | Pass |
| Benzene | 55 | BDL | BDL | BDL | Pass | Pass |
| Caprolactam | 120 | BDL | BDL | BDL | Pass | Pass |
| 2-Ethylhexanoic | | | | | | |
| acid | 46 | 157.0 | 2.9 | BDL | Pass | Pass |
| Formaldehyde | 50 | BDL | NT | NT | Pass | NT |
| 1-Methyl-2- | | | | | | |
| pyrrolidinone | 300 | BDL | 96.4 | BDL | Pass | Pass |
| Naphthalene | 20 | BDL | BDL | BDL | Pass | Pass |
| Nonanal | 24 | BDL | BDL | BDL | Pass | Pass |
| Octanal | 24 | BDL | BDL | BDL | Pass | Pass |
| 4- | | | | | | |
| Phenylcyclohexene | 50 | BDL | NT | NT | Pass | NT |
| Styrene | 410 | BDL | BDL | BDL | Pass | Pass |
| Toluene | 280 | BDL | 1.2 | BDL | Pass | Pass |
| Vinyl acetate | 400 | BDL | BDL | BDL | Pass | Pass |
| Other VOCs | | 4377.7 | 41.7 | 446.6 | NA | <500 |
| Total VOC | 500 | 4534.7 | 142.2 | 446.6 | NA | Pass |
| Total VOC from | | 4534.7 | 39.8 | 255.6 | NA | NT |
| PVB chip | | | | | | |
| Total VOC from | | 0.0 | 102.4 | 191.0 | NA | NT |
| carpet components | | | | | | |
| other than PVB | | | | | | |
| chip | | | | | | |
| Total | | 4534.7 | 142.2 | 446.6 | NA | <500 |

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the invention.

While the present invention is described herein in detail in relation to specific aspects, it is to be understood that this detailed description is only illustrative and exemplary of the present invention and is made merely for purposes of providing a full and enabling disclosure of the present invention. The detailed description set forth herein is not intended nor is to be construed to limit the present invention or otherwise to exclude any such other embodiments, adaptations, variations, modifications, and equivalent arrangements of the present invention, the present invention being limited solely by the claims appended hereto and the equivalents thereof.

1. A reinforced foam backing for a floor covering, the reinforced foam backing comprising:
a foam sheet comprising polyvinyl butyral, said foam sheet having a plurality of cells formed therein; and
at least one reinforcing material joined with said foam sheet.

2. The reinforced foam backing of claim 1, wherein the polyvinyl butyral comprises recycled polyvinyl butyral, virgin polyvinyl butyral, or any combination thereof.

3. The reinforced foam backing of claim 1, wherein the polyvinyl butyral comprises recycled polyvinyl butyral and, optionally, virgin polyvinyl butyral.

4. A floor covering comprising the reinforced foam backing of claim 3, the floor covering having a total volatile organic compound emission factor of less than about 1 mg/m²/hr as measured according to ASTM D-5116-1990.

5. A floor covering comprising the reinforced foam backing of claim 3, the floor covering having a total volatile organic compound emission factor of less than about 0.5 mg/m²/hr as measured according to ASTM D-5116-1990.

6. A floor covering comprising:
a carpet including a plurality of textile fibers at least partially embedded in a polymeric pre-coat layer comprising a polyurethane; and
a foam backing comprising polyvinyl butyral attached to said carpet.

7. The floor covering of claim 6, wherein the polyurethane has a glass transition temperature of from about −15° C. to about 10° C.

8. The floor covering of claim 6, wherein the polyurethane has a glass transition temperature of from about −5° C. to about 0° C.

9. The floor covering of claim 6, wherein the polyurethane has a tensile strength of from 1500 to about 5000.

10. The floor covering of claim 6, wherein the polyurethane is present in an amount of from about 5 to about 40 wt % of the floor covering on a dry/dry basis.

11. The floor covering of claim 6, further comprising a reinforcing material at least partially embedded in said foam backing.

12. The floor covering of claim 6, further comprising a reinforcing material joined to said foam backing.

13. A floor covering having a backing comprising recycled polyvinyl butyral, wherein the floor covering has a total volatile organic compound emission factor of less than about 1 mg/m²/hr as measured according to ASTM D-5116-1990.

14. The floor covering of claim 13, wherein the floor covering has a total volatile organic compound emission factor of less than about 0.75 mg/m²/hr as measured according to ASTM D-5116-1990.

15. The floor covering of claim 13, wherein the floor covering has a total volatile organic compound emission factor of less than about 0.5 mg/m²/hr as measured according to ASTM D-5116-1990.

16. The floor covering of claim 13, wherein the floor covering has a total volatile organic compound emission factor of less than about 0.375 mg/m²/hr as measured according to ASTM D-5116-1990.

17. The floor covering of claim 13, wherein the backing is a foam.

18. A floor covering comprising:
a carpet comprising a plurality of textile fibers;
a foamed backing comprising polyvinyl butyral joined to said carpet; and
a polymeric pre-coat layer joining said carpet to said foamed backing,
wherein said floor covering has a total volatile organic compound emission factor of less than about 0.5 mg/m²/hr as measured according to ASTM D-5116-1990.

19. The floor covering of claim 18, wherein said polymeric pre-coat layer comprises a polyurethane, polyvinyl butyral, or combination thereof.

20. The floor covering of claim 18, wherein said polymeric pre-coat layer comprises polyvinyl chloride, a tackified ethylene vinyl acetate copolymer, a tackified polyolefin, or any combination thereof.

21. The floor covering of claim 18, further comprising a reinforcing material joined to said foam backing.

22. The floor covering of claim 18, wherein the polyvinyl butyral in said backing comprises recycled polyvinyl butyral and, optionally, virgin polyvinyl butyral.

23. The floor covering of claim 18, wherein the polyvinyl butyral in said backing comprises recycled polyvinyl butyral, virgin polyvinyl butyral, or any combination thereof.

24. A method of manufacturing a floor covering, the method comprising:
extruding a polymeric material mixture comprising molten polyvinyl butyral and a cell-forming material;
calendering the extruded polymeric mixture to form a sheet; and
heating the sheet to form a foamed polyvinyl butyral backing.

25. The method of claim 24, further comprising at least partially embedding a reinforcing material into the calendered polymeric sheet to form a reinforced backing.

26. The method of claim 24, further comprising adhering a reinforcing material to the polyvinyl butyral backing to form a reinforced backing.

27. The method of claim 24, further comprising joining the foamed polyvinyl butyral backing to a carpet.

28. The method of claim 24, wherein the extruding further comprises removing volatile organic compounds from the polymeric material mixture.

29. A method of making a floor covering including a recycled PVB foam backing, the floor covering having a total volatile organic compound emission factor of less than about 0.5 mg/m²/hr as measured according to ASTM D-5116-1990, the method comprising:
extruding a polymeric material mixture comprising molten recycled polyvinyl butyral and a cell-forming material;
calendering the extruded polymeric mixture to form a sheet; and
heating the sheet to form a foamed polyvinyl butyral backing,
wherein at least one of the extruding, calendering, and heating are carried out at a temperature sufficient to release volatile organic compounds from the polymeric material mixture.

30. The method of claim 29, wherein the extruding is carried out at a temperature of from about 300° F. to about 350° F.

31. The method of claim 29, wherein the calendering is carried out at a temperature of from about 190° F. to about 350° F.

32. The method of claim 29, wherein the heating is carried out at a temperature of from about 300° F. to about 450° F.
